(19) United States
(12) Patent Application Publication
(10) Pub. No.: US 2016/0021967 A1
(43) Pub. Date: Jan. 28, 2016

(54) BICYCLE HELMET

(71) Applicant: ABUS August Bremicker Söhne KG, Wetter-Volmarstein (DE)

(72) Inventor: Remi Finiel, Mont Sur Rolle (CH)

(21) Appl. No.: 14/618,372

(22) Filed: Feb. 10, 2015

(30) Foreign Application Priority Data
Jul. 24, 2014 (DE) DE102014110480.3
Jul. 24, 2014 (EM) EM002508481

(51) Int. Cl. A42B 3/28; B29C 44/12; B29C 45/00

(52) U.S. Cl. CPC A42B 3/283; B29C 45/0062; B29C 45/006; B29C 44/1228; B29K 2055/02

(57) ABSTRACT

A bicycle helmet comprises a shock-absorbing helmet body and an outer shell for the helmet body, wherein the outer shell is produced from acrylonitrile butadiene styrene (ABS) and wherein a plurality of ventilation openings extend through the outer shell and through the helmet body. The proportion of the free surface defined by the ventilation openings amounts to at least 12% relative to the total surface of the outer shell.

The present invention relates to a bicycle helmet having a shock-absorbing helmet body and having an outer shell for the helmet body, wherein the outer shell is produced from acrylonitrile butadiene styrene (ABS) and wherein a plurality of ventilation openings extend through the outer shell and through the helmet body.

Bicycle helmets having a hard ABS outer shell are available as skater helmets or BMX helmets. Such skater helmets or BMX helmets are particularly robust and have a particularly long life due to the high impact strength and to the low shock sensitivity of ABS. The comfort in wear is in contrast comparatively small, in particular due to the relatively high weight and to the typically only small ventilation effect. Conventional skater helmets or BMX helmets having an ABS outer shell namely typically only have very small ventilation openings which are, for example, slit-shaped and which extend in two rows next to one another. Skater helmets or BMX helmets are therefore still only used occasionally for cycling over longer distances.

Bicycle helmets are specifically preferably used for cycling in the city, for cycle racing or for mountain biking which have a thin cover of polyvinyl chloride (PVC), polyethylene terephthalate (PET) or of a polycarbonate (PC) instead of a hard ABS outer shell, with occasionally a stiffening structure being integrated into the helm body, for example in the form of a lattice structure. Such bicycle helmets have a relatively high comfort in wear due to the small weight and to the good ventilation. In addition, the cover of PVC, PET or PC can be utilized as a base for optically appealing decors. However, such bicycle helmets are relatively sensitive to shock at their outer side and frequently suffer damage even on weak shocks such as occur on transport. Bicycle helmets having a cover of PVC, PET or PC are therefore less suitable for harsh use.

It is thus an object of the invention to provide a bicycle helmet having extended possibilities for use.

The object is satisfied in accordance with a first aspect of the invention by a bicycle helmet having a shock-absorbing helmet body and having an outer shell for the helmet body, wherein the outer shell is produced from acrylonitrile butadiene styrene (ABS) and wherein a plurality of ventilation openings extend through the outer shell and through the helmet body, with the proportion of the free surface defined by the ventilation openings amounting to at least 12% with respect to the total surface of the outer shell.

The object indicated above is satisfied in accordance with a second aspect of the invention by a bicycle helmet having a shock absorbing helmet body and an outer shell for the helmet body, wherein the outer shell is produced from acrylonitrile butadiene styrene and wherein a plurality of ventilation openings extend through the outer shell and through the helmet body, wherein the outer shell forms at least two longitudinal connection webs which extend at least sectionally along a longitudinal direction of the bicycle helmet, wherein a respective longitudinal row of a plurality of ventilation openings is provided at both sides of the arrangement of longitudinal connection webs and between the longitudinal connection webs, wherein the outer shell furthermore forms at least two transverse connection webs which intersect the longitudinal connection webs, wherein a respective transverse row of a plurality of ventilation openings is provided at both sides of the arrangement of transverse connection webs and between the transverse connection webs, wherein the ventilation openings of the longitudinal rows and the ventilation openings of the transverse rows are substantially quadrangular.

In accordance with the first aspect of the invention, the proportion of the free surface defined by the ventilation openings amounts to at least 12% with respect to the total surface of the outer shell. Contrary to the conventional principles of bicycle helmet design for skater helmets or BMX helmets having an ABS outer shell, a relatively large number of ventilation openings and/or relatively large ventilation openings are therefore provided in a helmet having an impact-resistant outer shell. Due to the increased ventilation effect and to the reduced weight, such a helmet is not only suitable as a skater helmet or BMX helmet for special stresses, but also for normal use, e.g. for cycling in the city. A bicycle helmet in accordance with the invention is, however, characterized by increased robustness and long life with respect to a conventional racing bicycle helmet.

A ventilation opening is generally to be understood as an opening which extends from the outside of the outer shell in a throughgoing manner up to the inside of the helmet body. The calculation of the named proportion of the free surface relates in connection with the invention to the outside of the outer shell, in particular up to the respective separation plane between the outer shell and the helmet body. If therefore the outer shell is set back in the environment of the respective ventilation opening and/or is arched in the direction of the ventilation opening, the set-back or arched surface sections should be included in the calculation.

A bicycle helmet generally has a concavely arched inside and a convexly arched outside so that accordingly the terms “outside” and “inside” in connection with the invention relate to the correspondingly arched surfaces. Indications of location and direction in connection with the invention generally relate to the arrangement of the bicycle helmet at or on the head of a user in accordance with its intended use. The term “front side”, for example, designates the side of the bicycle helmet disposed in the forehead region of the user and thus facing in the direction of gaze of the user, whereas the term “rear side” relates to the side of the bicycle helmet disposed in the area of the back of the head and the neck of the user and thus facing against the direction of gaze of the user. The “longitudinal direction” is to be understood as that direction which extends between the front side and the rear side of the bicycle helmet.

The proportion of the free surface defined by the ventilation openings relative to the total surface of the outer shell preferably amounts to at least 14%, particularly preferably to at least 16%. In other words, it is preferred for the proportion of the free surface to be considerably increased in comparison with the proportion of the free surface of conventional skater helmets or BMX helmets. With conventional skater helmets or BMX helmets, the proportion of the free surface relative to the total surface of the outer shell typically only amounts to between 4% and 8%. A considerably increase in the ventilation effect accordingly results.

In accordance with the second aspect of the invention, the outer shell forms at least two longitudinal connection webs which extend sectionally or in a throughgoing manner along a longitudinal direction of the bicycle helmet, wherein a respective longitudinal row of a plurality of ventilation openings is provided at both sides of the arrangement of longitudinal connection webs and between the longitudinal connection webs, wherein the outer shell furthermore forms at least two transverse connection webs which intersect the longitudinal connection webs, wherein a respective transverse row of a plurality of ventilation openings is provided at both sides of the arrangement of transverse connection webs and between the cross-connection webs, and wherein the ventilation openings of the longitudinal rows and the ventilation openings of the transverse rows are substantially quadrangular.

The arrangement of intersecting longitudinal connection webs and transverse connection webs so-to-say forms a lattice structure of the outer shell. In this manner, a high stability of the bicycle helmet, in particular a high tensile strength in the longitudinal direction and in the transverse direction, results despite the high free surface proportion. At least three longitudinal rows of a respective plurality of ventilation openings and at least three transverse rows of a respective plurality of ventilation openings are provided, wherein the ventilation openings of the longitudinal rows at least partly correspond to the ventilation openings of the transverse rows. The free surface provided by the ventilation openings is thereby particularly large. The longitudinal connection webs, like the transverse connection webs, can be in a straight line or in curve shape with respect to the convexly shaped outside of the bicycle helmet—that is viewed in projection.

The fact that the ventilation openings of the longitudinal rows and of the transverse rows are substantially quadrangular means that they have a quadrangular base shape, but with the corners being able to be rounded or chamfered. The ventilation openings can, for example, have a diamond-shaped or trapezoid base shape. A maximization of the free surface of the outer shell is achieved by the substantially quadrangular shape of the ventilation openings, in particular in the region between the longitudinal connection webs and the transverse connection webs, without the stability of the bicycle helmet (tensile strength in the longitudinal direction and in the transverse direction) becoming impaired too much and without the individual ventilation openings becoming too large (risk of penetration of objects).

The first aspect of the invention of a high free surface proportion and the second aspect of the invention of the forming of longitudinal connection webs, transverse connection web, longitudinal rows of ventilation openings and transverse rows of ventilation openings represent two alternative aspects of the common higher-ranking idea of providing a bicycle helmet both with a hard and stable outer shell and with a large-area arrangement of ventilation openings. The two aspects of the invention can be combined in an advantageous manner.

It is of advantage with the second aspect of the invention for a section of a respective longitudinal connection web disposed between a pair of ventilation openings to be arranged in an extension of another section of the respective longitudinal connection web which is disposed between an adjacent pair of ventilation openings. It is equally of advantage for a section of a respective transverse connection web disposed between a pair of ventilation openings to be arranged in an extension of another section of the respective transverse connection web which is disposed between an adjacent pair of ventilation openings. In other words, the respective longitudinal connection web or transverse connection web of the outer shell preferably extends in a throughgoing manner such that a section of the longitudinal connection web or of the transverse connection web is arranged in alignment of an adjacent section of the longitudinal connection web or transverse connection web (and is not, for instance, arranged laterally offset therefrom). However, this does not preclude that the respective longitudinal connection web or transverse connection web carries out a change of direction (e.g. as a curve track) along the outside of the bicycle helmet.

The transverse connection webs can in particular extend at least sectionally along a transverse direction of the bicycle helmet which extends at right angles to the longitudinal direction. It is furthermore preferred that the longitudinal connection webs extend next to one another and do not intersect. The transverse connection webs also preferably extend next to one another and do not intersect.

A specific embodiment of the invention provides that the outer shell forms two further longitudinal connection webs which extend at both sides of the named arrangement of longitudinal rows of ventilation openings, with the transverse connection webs also intersecting the two further longitudinal connection webs. In this embodiment, an again extended lattice structure is present.

The at least two longitudinal connection webs can extend up to a marginal section of the outer shell at the front side and/or up to a marginal section of the outer shell at the rear side. A particularly high tensile strength of the outer shell is hereby achieved in the longitudinal direction of the bicycle helmet.

Provision can alternatively or additionally be made that the at least two transverse connection web extend in a throughgoing manner between a marginal section at the left side and a marginal section at the right side of the outer shell. A particularly high tensile strength of the outer shell is hereby achieved in the transverse direction of the bicycle helmet.

The longitudinal connection webs or the transverse connection webs therefore represent major structural features of the bicycle helmet in these embodiments.

The longitudinal connection webs and the transverse connection webs can have a width of at least 1.5 cm and of at most 4 cm in the region between two ventilation openings which are separated from one another by the respective longitudinal connection web or transverse connection web and which are thus opposite one another with respect to the respective longitudinal connection web or transverse connection web. The named minimal value in this respect ensures the required stability of the bicycle helmet. The observation of the named maximum value in contrast means a relatively large proportion of the free surface defined by the ventilation openings with respect to the total surface of the outer shell.

It is preferred with respect to the two named aspects of the invention that the minimal width of a respective ventilation opening amounts to at least 2 cm. The minimal width of a ventilation opening is to be understood as that minimal value of the clear diameter of the respective ventilation opening which is relative to all the possible directions of observation along the surface of the bicycle helmet. It is therefore preferred to provide relatively large ventilation openings which are not, for instance, configured as particularly narrow in one direction (e.g. as ventilation slits). Large ventilation openings do not only provide an increased comfort in wear, but also give the bicycle helmet a visually appealing appearance. It can in particular be achieved by large ventilation openings that the bicycle helmet does not look like a typical skater helmet or BMX helmet despite the ABS shell, but rather looks like a racing bike helmet.

In accordance with a further embodiment of the invention, at least 16 ventilation openings and preferably at least 18 ventilation openings are provided. The provision of such large numbers of ventilation openings contributes to a particularly good ventilation effect and gives the bicycle helmet an appealing appearance.

The ventilation openings can be arranged distributed substantially evenly over the surface of the bicycle helmet, which is favorable with respect to the stability and the ventilation effect. When observing a respective region of the surface of the bicycle helmet which is larger than a single ventilation opening, but smaller than the total surface of the bicycle helmet, approximately the same proportion of the free surface thus always results within the region which is defined by the ventilation opening located within the region or by the plurality of ventilation openings located within the region, with respect to the total surface of the observed region. This applies independently of the position of the surface of the bicycle helmet which is selected as the observed region. The term “distributed substantially evenly over the surface of the bicycle helmet” is to be understood in this sense.

It is preferred that at least one respective ventilation opening is arranged in a front side region, in a rear side region, in a left side region, in a right side region and in an upper side region of the bicycle helmet. This means that it is preferred that the bicycle helmet is provided with ventilation openings all around and not only at individual isolated region as customary with skater helmets or BMX helmets.

It is further preferred that the outer shell is produced completely from acrylonitrile butadiene styrene (ABS). This ensures a high impact resistance and a small shock sensitivity. In addition, ABS is very suitable for the application of high-quality decor films.

An embodiment of the invention provides that the outer shell is designed as an inherently stiff hard shell and/or has a thickness of at least 2 mm. Such an outer shell is substantially more robust and has a longer life than the conventional films of PVC, PET or polycarbonate customary with racing bike helmets, for example. Such an inherently stiff and/or thick outer shell of ABS can particularly advantageously be manufactured by an injection process.

The helmet body can be produced from an expanded polystyrene hard foam (EPS). Such helmet bodies can absorb shocks particularly well.

The helmet body is preferably designed without damping cut-outs and/or without a stiffening structure integrated into the helmet body. Damping cut-outs such as attenuation ribs are customary or even absolutely necessary in conventional skater helmets or BMX helmets to achieve a desired damping characteristic. However, special adaptations at the tool for manufacturing the helmet body are customary for this purpose. In contrast, it is required with racing bike helmets to integrate a stiffening structure, for example in the form of a lattice structure, into the helmet body (e.g. by insert molding or insert foaming of the stiffening structure during the manufacture of the helmet body) to ensure sufficient stability. It was recognized within the framework of the invention that it is possible on provision of an impact-resistant outer shell with a high free surface proportion and/or with longitudinal webs and transverse webs to dispense both with stiffening elements integrated into the helmet body and with damping cut-outs in the helmet body. The manufacturing costs for a bicycle helmet can thus be reduced.

A further embodiment of the invention provides that the inside of the outer shell is concave and has an angle of extent along a longitudinal direction of the bicycle helmet which is larger than 180°. Such a design is also called a “negative curvature”. Viewed in a central longitudinal sectional plane, the orthogonal which is formed on the extent of the inside of the outer shell in a front side region of the bicycle helmet in this respect intersect that orthogonal which is formed on the extent of the inside of the outer shell in a rear side region of the bicycle helmet at a reflex angle, that is at an angle of more than 180°. A particular wide surrounding of the head of the user (in the longitudinal direction of the bicycle helmet) is hereby achieved.

On manufacture, the helmet body can be pushed into such an outer shell having a negative curvature and can subsequently be adhesively bonded to it. A bicycle helmet in accordance with the invention can, however, generally also be manufactured in a so-called in-mold process, wherein the outer shell is inserted into an injection mold, wherein the EPS forming the helmet body is injected or foamed onto the outer shell.

In accordance with an embodiment of the invention, the helmet body and the outer shell are designed as separate elements adhesively bonded to one another. This manner of construction is in particular of advantage when the outer shell has a negative curvature.

In accordance with a further embodiment of the invention, a peak can be attached to the outer shell and/or to the helmet body.

The invention also relates to a method of manufacturing a bicycle helmet which is designed as described above (i.e. in accordance with the first aspect of the invention or with the second aspect of the invention).

Provision is made in the method in accordance with the invention that—unlike a customary deep-drawing method—the outer shell is produced by injection and the helmet body is attached to an inside of the injected outer shell. This type of manufacture is particularly inexpensive. In addition, there is a comparatively large flexibility with respect to design with injection processes so that e.g. outer shells can be easily manufactured in different thicknesses and in particular in relatively large thicknesses.

The helmet body can be attached to the inside of the outer shell by adhesive bonding or in an in-mold process by injection or foaming.

Further developments of the invention are set forth in the dependent claims, in the description and in the enclosed drawings.

The invention will be described in the following by way of example with reference to the drawings.

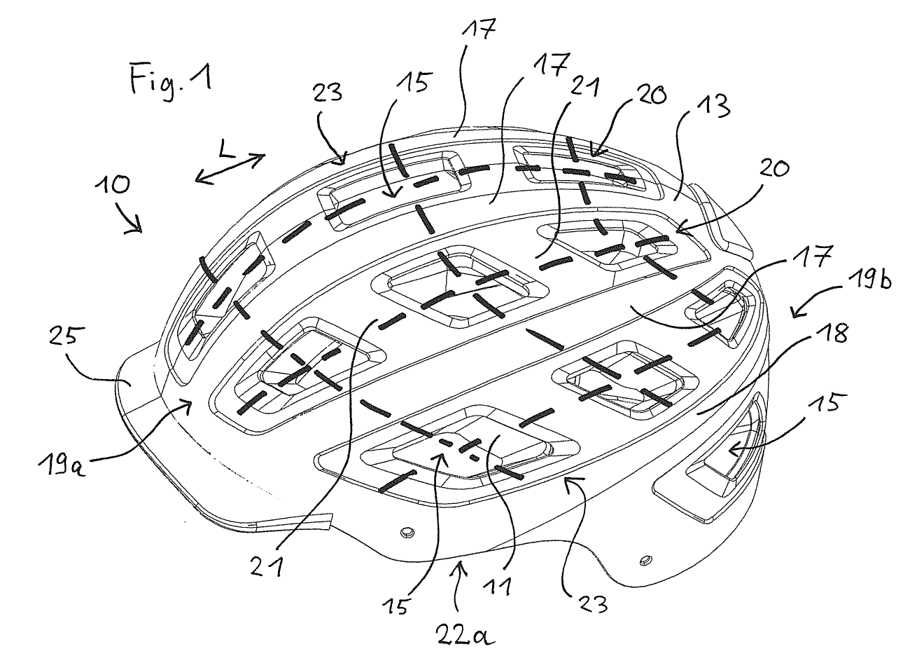

FIG. 1 shows a bicycle helmet in accordance with an embodiment of the invention in perspective view obliquely from the front and from above;

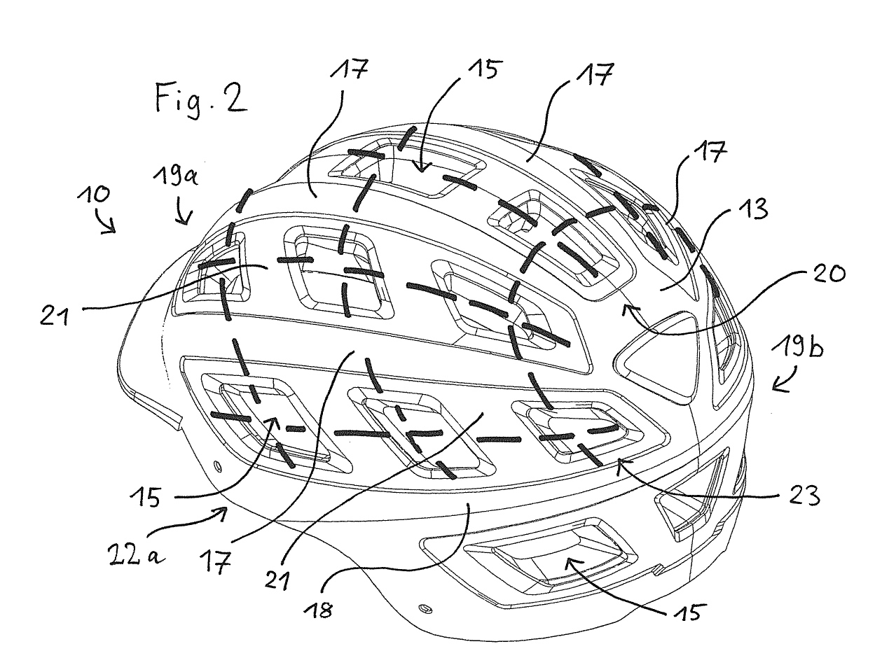

FIG. 2 shows the bicycle helmet in accordance with FIG. 1 obliquely from the rear and from above;

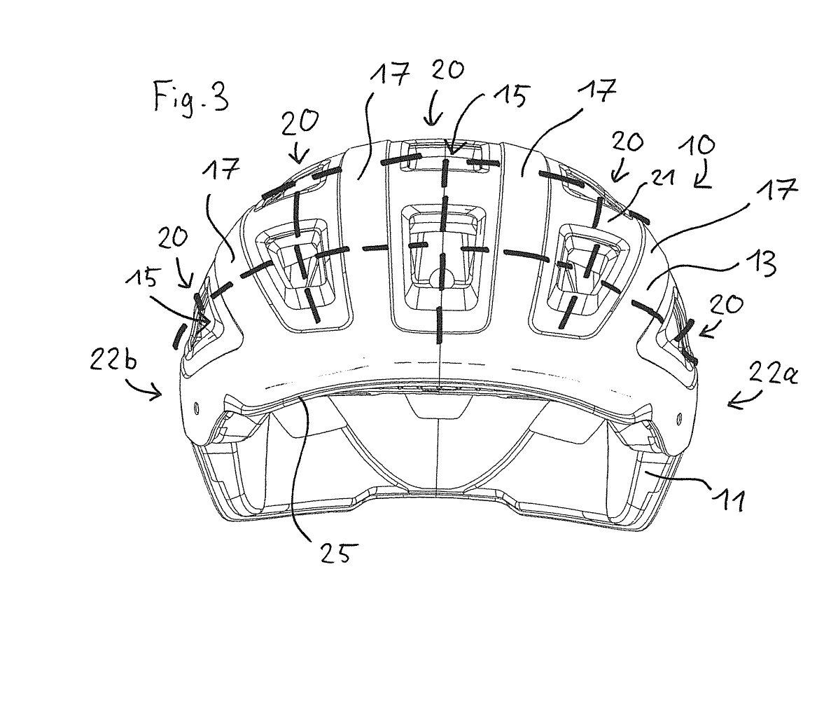

FIG. 3 shows the bicycle helmet in accordance with FIG. 1 from the front;

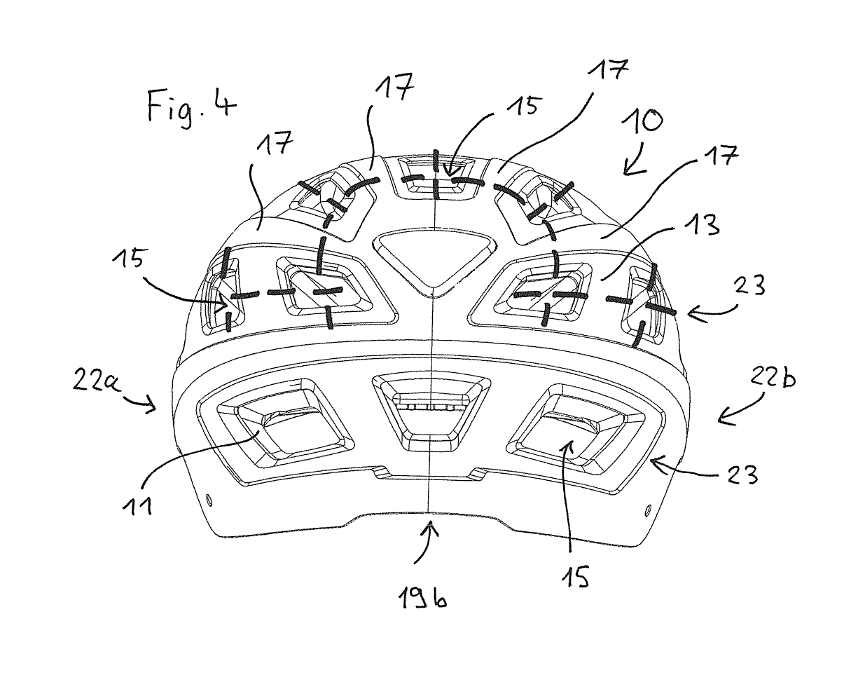

FIG. 4 shows the bicycle helmet in accordance with FIG. 1 from the rear;

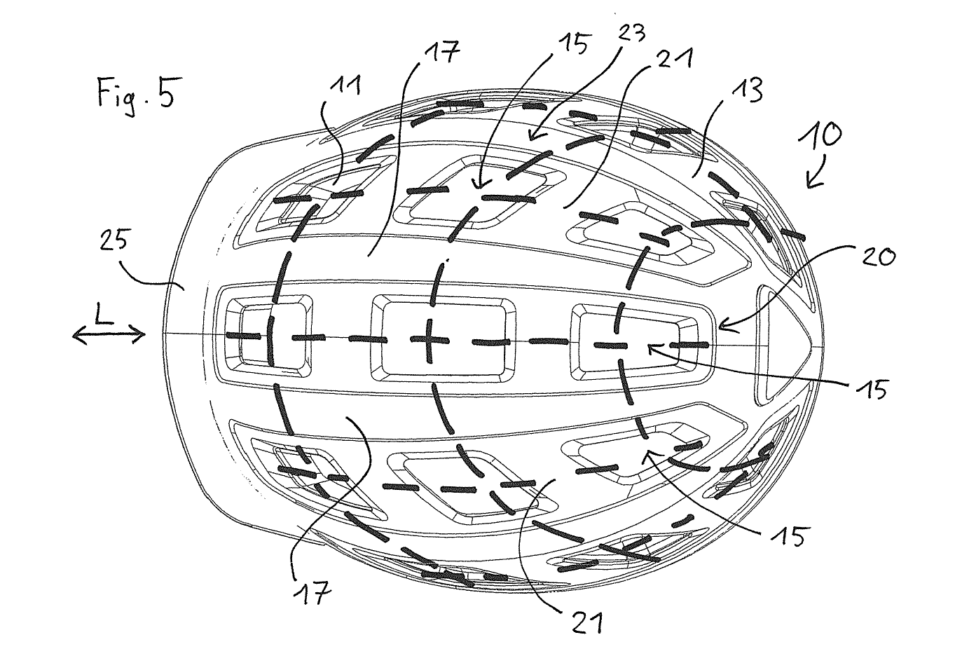

FIG. 5 shows the bicycle helmet in accordance with FIG. 1 from above;

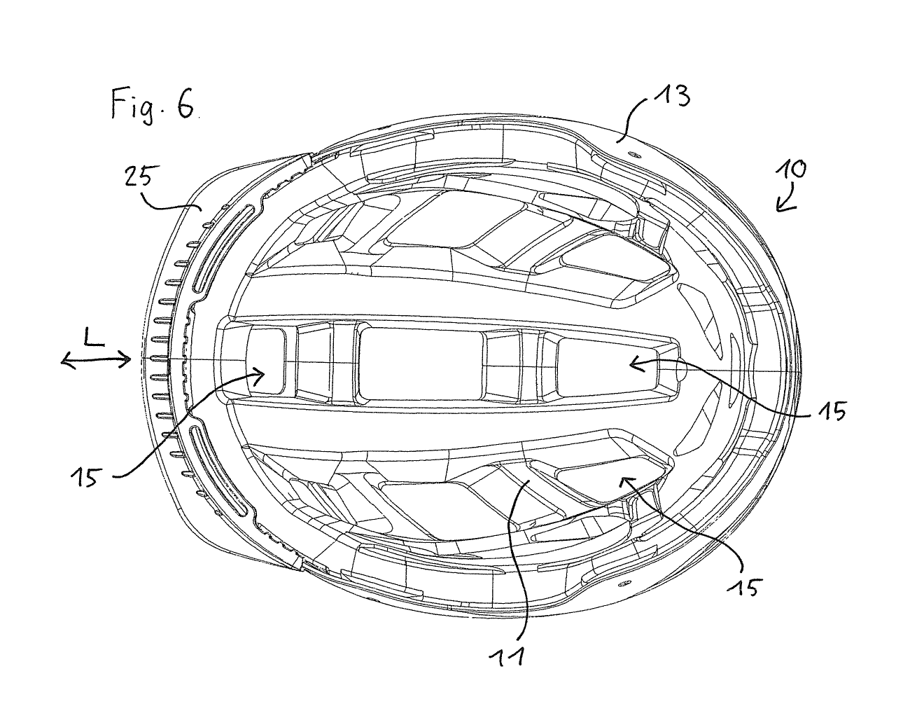

FIG. 6 shows the bicycle helmet in accordance with FIG. 1 from below;

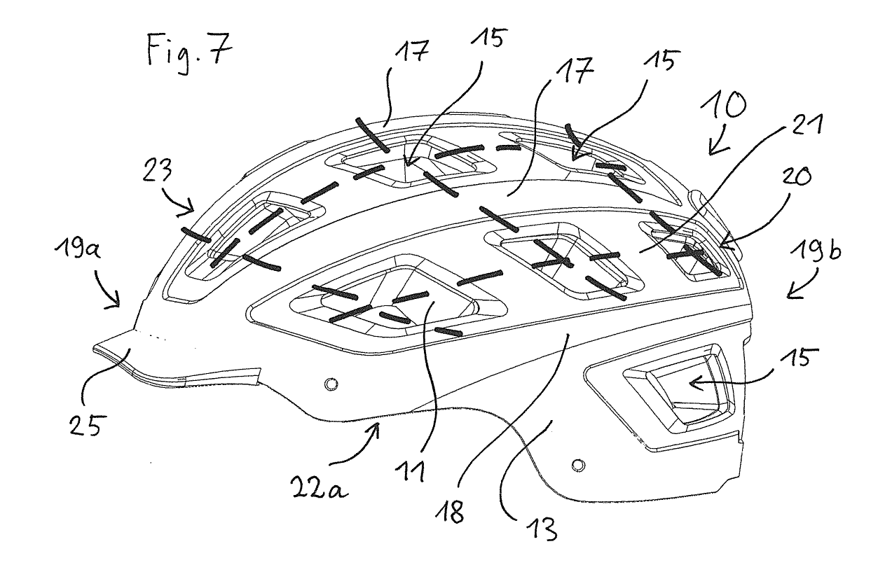

FIG. 7 shows the bicycle helmet in accordance with FIG. 1 from the side;

The bicycle helmet 10 shown in different views in FIGS. 1 to 7 has a shock-absorbing helmet body 11 of an expanded polystyrene hard foam (EPS) and an outer shell 13 connected to the helmet body 11. The outer shell 13 is produced completely from acrylonitrile butadiene styrene (ABS) and has a thickness of approximately 2 mm. The outer shell 13 accordingly has inherent stiffness. The manufacture of the outer shell 13 preferably takes place by injection, wherein the helmet body 12 is attached to the outer shell 13 after the injection process. The helmet body 11 can specifically be adhesively bonded to the outer shell 13 or can be directly foamed to it within the framework of an in-mold process. A plurality of ventilation openings 15 are arranged distributed over the surface of the outer shell 13 and extend through the outer shell 13 and through the helmet body 11. The ventilation openings 15 are arranged in a specific manner as will be shown in more detail in the following.

The arrangement of the ventilation openings 15 is specifically selected such that the outer shell 13 forms four longitudinal connection webs 17 which extend along a longitudinal direction L of the bicycle helmet 10, starting from a marginal section 19a of the outer shell 13 at the front side, in the direction of a marginal section 19b of the outer shell 13 at the rear side. The ventilation openings 15 furthermore form a total of five longitudinal rows 20 (shown dashed). The longitudinal rows 20 of ventilation openings 15 are arranged such that a respective longitudinal row 20 of a plurality of ventilation openings 15 extends between the four longitudinal connection webs 17 and at both sides of the arrangement of four longitudinal connection webs 17. Furthermore, a respective diagonal connection we 18 is provided at both sides of the arrangement of five longitudinal rows 20 of ventilation openings 15, the diagonal connection web extending, starting from a marginal section 22a at the left side or from a marginal section 22b of the outer shell 13 at the right side, obliquely to the longitudinal direction L in the direction of the rear side of the bicycle helmet 10.

The outer shell 13 also forms two curvilinearly curved transverse connection webs 21 which intersect the longitudinal connection webs 17. Furthermore, there are also three curvilinearly curved transverse rows 23 of ventilation openings 15 (likewise shown dashed) due to the arrangement of the ventilation openings 15, with in turn a respective transverse row 23 of ventilation openings 15 being present between the two transverse connection webs and at both sides of the arrangement of two transverse connection webs 21. The transverse connection webs 21 extend transversely to the longitudinal direction L (i.e. sectionally perpendicular or obliquely to the longitudinal direction L) between the marginal section 22a of the outer shell 13 at the left side and the marginal section 22b of the outer shell 13 at the right side.

The outer shell 13 of the bicycle helmet 10 thus has a lattice-like base structure overall. The ventilation openings 15 are formed in diamond shape or in trapezoid shape in the embodiment shown and have rounded corners. A peak 25 is arranged at the marginal section 19a of the outer shell 13 at the front side. If required, a visor can be provided instead of the peak 25 or in addition to the peak 25.

The minimal width of each ventilation opening 15 which is bounded by a longitudinal connection web 17 or by a transverse connection web 21 amounts to at least 2 cm. In the embodiment shown, this also applies to the three ventilation openings 15 additionally provided in the neck region of the bicycle helmet 10. The longitudinal connection webs 17 and the transverse connection webs 21 furthermore each have a width between 1.5 cm and 4 cm in the region between two ventilation openings 15 which are separated from one another by the respective longitudinal connection web 17 or transverse connection web 21.

The proportion of the free surface of the bicycle helmet 10 defined by the ventilation openings 15 is relatively large with respect to the total surface of the outer shell 13 due to the number and the size of the ventilation openings 15. In the embodiment shown, this proportion amounts to approximately 17%. The relevant demands with respect to the avoidance of injuries due to articles passing through the ventilation openings are nevertheless satisfied. A good ventilation effect for all regions of the head is ensured in the bicycle helmet 10 due to the largely even distribution of the ventilation openings 15 over the total surface of the outer shell 13. Due to the outer shell 13 which is inherently stiff and which is produced from hard ABS, it is not necessary to provide stiffening elements integrated into the helmet body 11. It is furthermore not necessary as with conventional skater helmets or BMX helmets due to the lattice-like structure to provide damping cut-outs such as attenuation ribs or the like in the helmet body 11. Due to the high impact resistance of ABS, the outer shell 13 is not only protected from damage on falls, but also, for example, on slight shocks during transport.

Overall, a bicycle helmet is provided by the invention which is distinguished both from skater helmets or BMX helmets and from racing bike helmets and which is specifically characterized by a combination of great robustness, on the one hand, and high comfort in wear, on the other hand.

### Reference Numeral List

10 bicycle helmet
11 helmet body
13 outer shell
15 ventilation opening
17 longitudinal connection web
18 diagonal connection web
19a marginal section at the front side
19b marginal section at the rear side
20 longitudinal row
21 transverse connection web
22a marginal section at the left side
22b marginal section at the right side
23 transverse row
25 peak
L longitudinal direction

1. A bicycle helmet (10) having a shock-absorbing helmet body (11) and having an outer shell (13) for the helmet body (11), wherein the outer shell (13) is produced from acrylonitrile butadiene styrene (ABS) and wherein a plurality of ventilation openings (15) extend through the outer shell (13) and through the helmet body (11), with the proportion of the free surface defined by the ventilation openings (15) amounting to at least 12% relative to the total surface of the outer shell (13).

2. A bicycle helmet in accordance with claim 1,
wherein the proportion of the free surface defined by the ventilation openings (15) amounts to at least 16% relative to the total surface of the outer shell (13).

3. A bicycle helmet in accordance with claim 1,
wherein the minimal width of each ventilation opening (15) amounts to at least 2 cm.

4. A bicycle helmet in accordance with claim 1,
wherein at least 16 ventilation openings (15) are provided.

5. A bicycle helmet in accordance with claim 4,
wherein at least 18 ventilation openings (15) are provided.

6. A bicycle helmet in accordance with claim 1, p1 wherein the ventilation openings (15) are arranged distributed substantially evenly over the surface of the bicycle helmet (10).

7. A bicycle helmet in accordance with claim 1,
wherein at least one respective ventilation opening (15) is arranged in a front side region, in a rear side region, in a left side region, in a right side region and in an upper side region of the bicycle helmet (10).

8. A bicycle helmet in accordance with claim 1,
wherein the outer shell (13) is completely produced from acrylonitrile butadiene styrene (ABS).

9. A bicycle helmet in accordance with claim 1,
wherein the helmet body (11) is produced from an expanded polystyrene hard foam (EPS).

10. A bicycle helmet in accordance with claim 1,
wherein the helmet body (11) is designed without damping cut-outs or without stiffening elements integrated into the helmet body (11) or without damping cut-outs and without stiffening elements integrated into the helmet body (11).

11. A bicycle helmet in accordance with claim 1, wherein the inside of the outer shell is concave and has an angle of extent along a longitudinal direction (L) of the bicycle helmet (10) which is larger than 180°.

12. A bicycle helmet in accordance with claim 1,
wherein the helmet body (11) and the outer shell (13) are designed as separate and mutually adhesively bonded elements.

13. A bicycle helmet (10) having a shock-absorbing helmet body (11) and having an outer shell (13) for the helmet body (11), wherein the outer shell (13) is produced from acrylonitrile butadiene styrene (ABS) and wherein a plurality of ventilation openings (15) extend through the outer shell (13) and through the helmet body (11), with the outer shell (13) forming at least two longitudinal connection webs (17) which extend at least sectionally along a longitudinal direction (L) of the bicycle helmet (10), wherein a respective longitudinal row (20) of a plurality of ventilation openings (20) is provided at both sides of the arrangement of longitudinal connection webs (17) and between the longitudinal connection webs (17), with the outer shell (13) furthermore forming at least two transverse connection webs (21) which intersect the longitudinal connection webs (17), wherein a respective transverse row (23) of a plurality of ventilation openings (15) is provided at both sides of the arrangement of transverse connection webs (21) and between the transverse connection webs (21), wherein the ventilation openings (15) of the longitudinal rows (20) and the ventilation openings (15) of the transverse rows (23) are substantially quadrangular.

14. A bicycle helmet in accordance with claim 13,
wherein the outer shell (13) forms two further longitudinal connection webs (17) which extend at both sides of the arrangement of longitudinal rows (20) of ventilation openings (15), with the transverse connection webs (21) also intersecting the two further longitudinal connection webs (17).

15. A bicycle helmet in accordance with claim 13,
wherein the at least two longitudinal connection webs (17) extend up to a marginal section (19a) of the outer shell (13) at the front side and/or up to a marginal section (19b) of the outer shell (13) at the rear side.

16. A bicycle helmet in accordance with claim 13,
wherein the at least two transverse connection webs (21) extend in a throughgoing manner between a marginal section (22a) at the left side and a marginal section (22b) of the outer shell (13) at the right side.

17. A bicycle helmet in accordance with claim 13, wherein the longitudinal connection webs (17) and the transverse connection webs (21) each have a width of at least 1.5 cm and of at most 4 cm in the region between two ventilation openings (15) which are separated from one another by the respective longitudinal connection web (17) or transverse connection web (21).

18. A bicycle helmet in accordance with claim 13,
wherein the proportion of the free surface defined by the ventilation openings (15) amounts to at least 12% relative to the total surface of the outer shell (13).

19. A bicycle helmet in accordance with claim 18,
wherein the proportion of the free surface defined by the ventilation openings (15) amounts to at least 16% relative to the total surface of the outer shell (13).

20. A bicycle helmet in accordance with claim 13,
wherein the minimal width of each ventilation opening (15) amounts to at least 2 cm.

21. A bicycle helmet in accordance with claim 13,
wherein at least 16 ventilation openings (15) are provided.

22. A bicycle helmet in accordance with claim 21,
wherein at least 18 ventilation openings (15) are provided.

23. A bicycle helmet in accordance with claim 13,
wherein the ventilation openings (15) are arranged distributed substantially evenly over the surface of the bicycle helmet (10).

24. A bicycle helmet in accordance with claim 13,
wherein at least one respective ventilation opening (15) is arranged in a front side region, in a rear side region, in a left side region, in a right side region and in an upper side region of the bicycle helmet (10).

25. A bicycle helmet in accordance with claim 13,
wherein the outer shell (13) is completely produced from acrylonitrile butadiene styrene (ABS).

26. A bicycle helmet in accordance with claim 13,
wherein the helmet body (11) is produced from an expanded polystyrene hard foam (EPS).

27. A bicycle helmet in accordance with claim 13,
wherein the helmet body (11) is designed without damping cut-outs or without stiffening elements integrated into the helmet body (11) or without damping cut-outs and without stiffening elements integrated into the helmet body (11).

28. A bicycle helmet in accordance with claim 13,
wherein the inside of the outer shell is concave and has an angle of extent along a longitudinal direction (L) of the bicycle helmet (10) which is larger than 180°.

29. A bicycle helmet in accordance with claim 13,
wherein the helmet body (11) and the outer shell (13) are designed as separate and mutually adhesively bonded elements.

30. A method of manufacturing a bicycle helmet (10) which has a shock-absorbing helmet body (11) and which has an outer shell (13) for the helmet body (11), wherein a plurality of ventilation openings (15) extend through the outer shell (13) and through the helmet body (11), with the outer shell (13) forming at least two longitudinal connection webs (17) which extend at least sectionally along a longitudinal direction (L) of the bicycle helmet (10), wherein a respective longitudinal row (20) of a plurality of ventilation openings (20) is provided at both sides of the arrangement of longitudinal connection webs (17) and between the longitudinal connection webs (17), with the outer shell (13) furthermore forming at least two transverse connection webs (21) which intersect the longitudinal connection webs (17), wherein a respective transverse row (23) of a plurality of ventilation openings (15) is provided at both sides of the arrangement of transverse connection webs (21) and between the transverse connection webs (21), wherein the ventilation openings (15) of the longitudinal rows (20) and the ventilation openings (15) of the transverse rows (23) are substantially quadrangular,
comprising the steps:
manufacturing the outer shell (13) from acrylonitrile butadiene styrene (ABS) by injection; and
attaching the helmet body (11) to an inside of the injected outer shell (13).

31. A method in accordance with claim 30,
wherein the helmet body (11) is attached to the inside of the outer shell (13) by adhesive bonding, injection or foaming.
